(19) United States
(12) Patent Application Publication
(10) Pub. No.: US 2025/0210273 A1
(43) Pub. Date: Jun. 26, 2025

(54) MULTILAYER ELECTRONIC COMPONENT

(71) Applicant: SAMSUNG ELECTRO-MECHANICS CO., LTD., Suwon-si (KR)

(72) Inventors: Kwang Hee NAM, Suwon-si (KR); Yun KIM, Suwon-si (KR); Joon Yeob CHO, Suwon-si (KR); Young Ghyu AHN, Suwon-si (KR); Jea Yeol CHOI, Suwon-si (KR)

(73) Assignee: SAMSUNG ELECTRO-MECHANICS CO., LTD., Suwon-si (KR)

(21) Appl. No.: 18/925,966

(22) Filed: Oct. 24, 2024

(30) Foreign Application Priority Data
Dec. 20, 2023 (KR) 10-2023-0187344

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/12; H01G 4/232

(57) ABSTRACT

A multilayer electronic component includes a body including a dielectric layer and first and second internal electrodes alternately disposed with the dielectric layer therebetween, an external electrode including a connection portion and a band portion extending from the connection portion onto at least one of the first, second, fifth and sixth surfaces. The external electrode includes a base electrode layer, a lower plating layer disposed on the base electrode layer, and an upper plating layer disposed on the lower plating layer. The body includes a groove disposed on end of the band portion. Ends of the lower and upper plating layers respectively fill at least portions of the groove.

### CROSS-REFERENCE TO RELATED APPLICATION(S)

This application claims benefit of priority to Korean Patent Application No. 10-2023-0187344 filed on Dec. 20, 2023 in the Korean Intellectual Property Office, the disclosure of which is incorporated herein by reference in its entirety.

### TECHNICAL FIELD

The present disclosure relates to a multilayer electronic component.

### BACKGROUND

Multilayer ceramic capacitors (MLCC), a type of multilayer electronic component, are chip-shaped capacitors mounted on the printed circuit boards of various electronic products such as Liquid Crystal Display (LCD) and Plasma Display Panel (PDP) display devices, computers, smartphones, and mobile phones to charge or discharge electricity therein or therefrom. These multilayer ceramic capacitors may be used as components of various electronic devices due to advantages thereof of being small, having high capacity, and being easy to install.

Recently, as the usage environment of multilayer ceramic capacitors has become harsher, problems have arisen where external moisture, etc. penetrate into the body, deteriorating the insulation breakdown voltage of multilayer ceramic capacitors. Accordingly, research is being undertaken to improve the moisture resistance reliability of multilayer ceramic capacitors.

### SUMMARY

An aspect of the present disclosure is to provide a multilayer electronic component having excellent reliability.

According to an aspect of the present disclosure, a multilayer electronic component includes a body including a dielectric layer, and a first internal electrode and a second internal electrode alternately disposed with the dielectric layer therebetween, the body including a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction; a first external electrode including a first connection portion disposed on the third surface and a first band portion extending from the first connection portion onto at least one surface among the first surface, the second surface, the fifth surface, and the sixth surface; and a second external electrode including a second connection portion disposed on the fourth surface and a second band portion extending from the second connection portion onto at least one surface among the first surface, the second surface, the fifth surface, and the sixth surface. The first external electrode includes a first base electrode layer in contact with the first internal electrode, a first lower plating layer disposed on the first base electrode layer, and a first upper plating layer disposed on the first lower plating layer. The second external electrode includes a second base electrode layer in contact with the second internal electrode, a second lower plating layer disposed on the second base electrode layer, and a second upper plating layer disposed on the second lower plating layer. The body includes a first groove and a second groove disposed on ends of the first and second band portions, respectively, and spaced apart from each other. Ends of the first lower plating layer and the first upper plating layer respectively fill at least portions of the first groove, and ends of the second lower plating layer and the second upper plating layer respectively fill at least portions of the second groove.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment;

FIG. 2 is a perspective view schematically illustrating a body of FIG. 1;

FIG. 3 is a plan view schematically illustrating a multilayer electronic component as viewed from a first surface of FIG. 1;

FIG. 4 is a cross-sectional view schematically illustrating a cross-section taken along line I-I′ of FIG. 1;

FIG. 5 is a cross-sectional view schematically illustrating a cross-section taken along line II-II′ of FIG. 1;

FIG. 6 is a cross-sectional view schematically illustrating a cross-section taken along line III-III′ of FIG. 4;

FIG. 7 is an enlarged view of area A of FIG. 4;

FIG. 8 is a modified example of FIG. 7;

FIG. 9 is a modified example of FIG. 4;

FIG. 10 is a cross-sectional view schematically illustrating a multilayer electronic component according to another embodiment, and is a drawing corresponding to FIG. 4;

FIG. 11 is an enlarged view of area B of FIG. 10; and

FIG. 12 is a plan view of a multilayer electronic component according to another embodiment, and is a drawing corresponding to FIG. 3; and

FIG. 13 is an enlarged view schematically illustrating a multilayer electronic component of the related art, and is a drawing corresponding to FIG. 7.

### DETAILED DESCRIPTION

Hereinafter, embodiments of the present disclosure will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

In addition, to clearly describe the present disclosure drawings, parts irrelevant to the description are omitted, and the size and thickness of each component illustrated in the drawings are arbitrarily illustrated for convenience of description, and thus, the present disclosure is not necessarily limited to the illustrated embodiment. Also, components having the same function within the scope of the same concept are described using the same reference numerals. Furthermore, throughout the specification, when a certain component is said to “include,” it means that it may further include other components without excluding other components unless otherwise stated.

In one or more aspects, the terms “substantially,” “about,” and “approximately” may provide an industry-accepted tolerance for their corresponding terms and/or relativity between items, such as a tolerance of ±1%, ±5%, or ±10% of the actual value stated, and other suitable tolerances.

In the drawings, the first direction may be defined as the thickness (T) direction, the second direction may be defined as the length (L) direction, and the third direction may be defined as the width (W) direction.

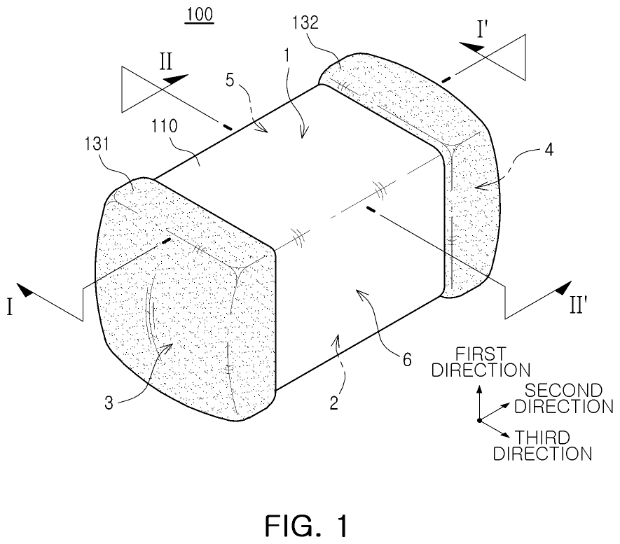

FIG. 1 is a perspective view schematically illustrating a multilayer electronic component according to an embodiment.

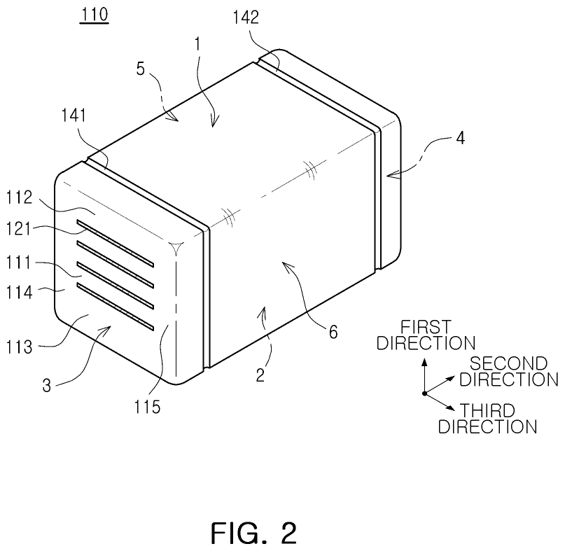

FIG. 2 is a perspective view schematically illustrating a body of FIG. 1.

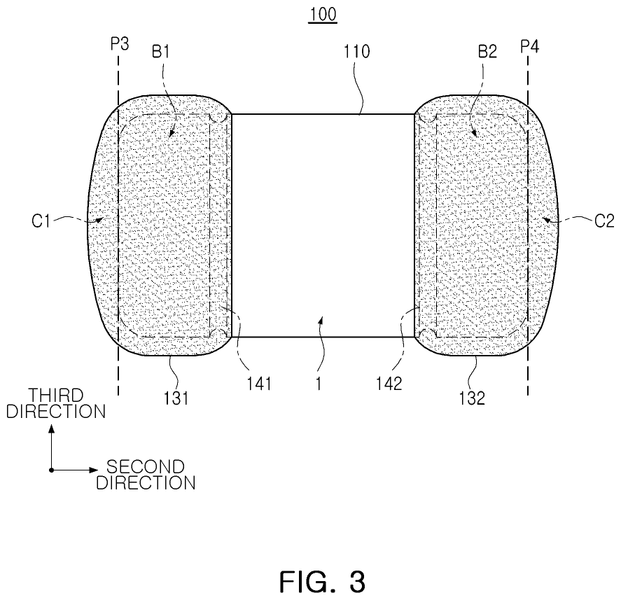

FIG. 3 is a plan view schematically illustrating a multilayer electronic component as viewed from a first surface of FIG. 1.

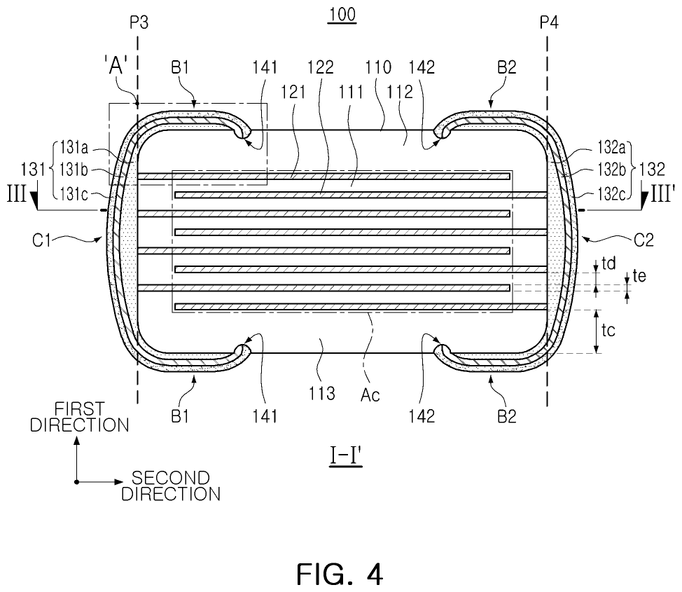

FIG. 4 is a cross-sectional view schematically illustrating a cross-section taken along line I-I′ of FIG. 1.

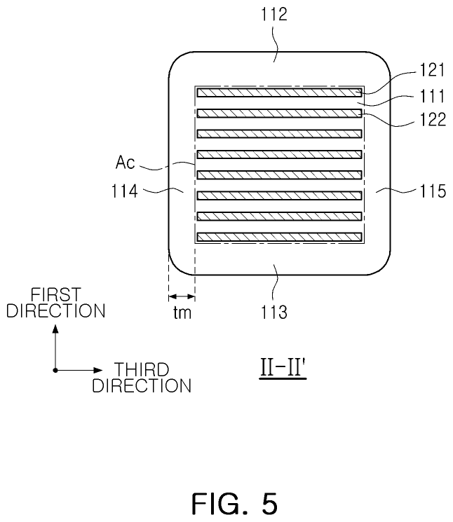

FIG. 5 is a cross-sectional view schematically illustrating a cross-section taken along line II-II′ of FIG. 1.

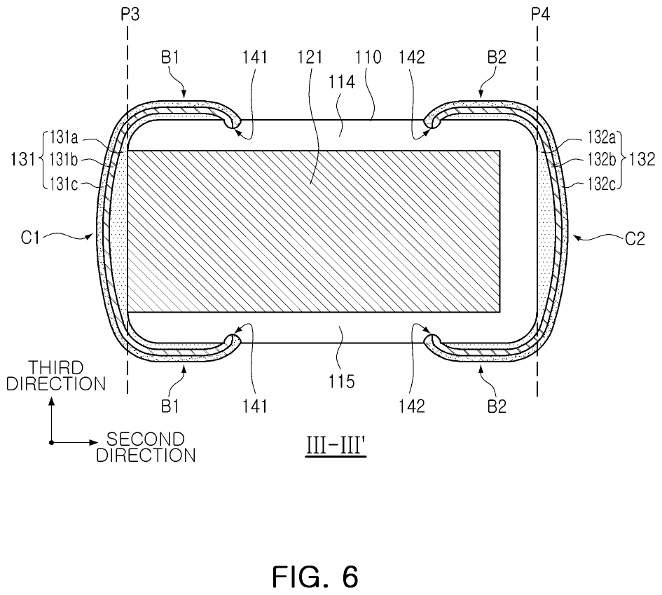

FIG. 6 is a cross-sectional view schematically illustrating a cross-section taken along line III-III′ of FIG. 4.

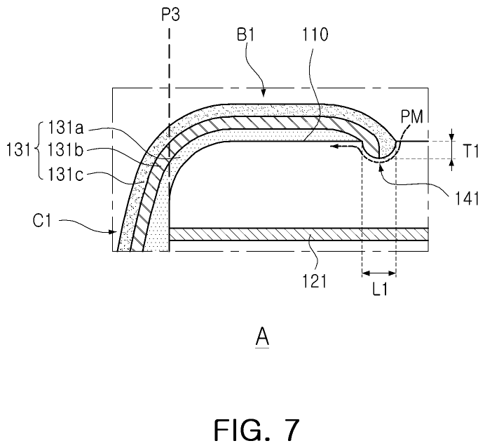

FIG. 7 is an enlarged view of area A of FIG. 4.

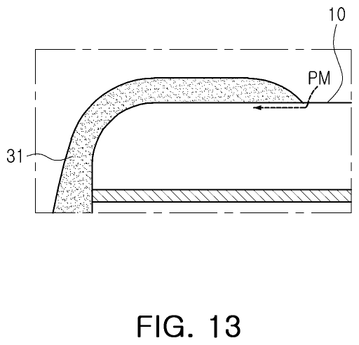

FIG. 13 is an enlarged view schematically illustrating a multilayer electronic component of the related art, and is a drawing corresponding to FIG. 7.

Hereinafter, a multilayer electronic component 100 according to an embodiment will be described in detail with reference to FIGS. 1 to 7. In addition, a multilayer ceramic capacitor is described as an example of a multilayer electronic component, but the present disclosure is not limited thereto and may be applied to various multilayer electronic components, such as inductors, piezoelectric elements, varistors, or thermistors.

The size of the multilayer electronic component 100 is not particularly limited. A maximum size of the multilayer electronic component 100 in the second direction may be, for example, 0.2 mm to 3.2 mm, and a maximum size of the multilayer electronic component 100 in the third direction may be, for example, 0.1 mm to 1.6 mm.

Referring to FIG. 1, the multilayer electronic component 100 may include a body 110 and external electrodes 131 and 132 disposed on the body 110.

There is no particular limitation on the detailed shape of the body 110, but as illustrated in FIG. 2, the body 110 may have a hexahedral shape or a similar shape. Due to shrinkage of the ceramic powder particle contained in the body 110 during sintering process or polishing process of the corners, the body 110 may not have a hexahedral shape with completely straight lines, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3 and 4 and opposing each other in the third direction.

Referring to FIG. 4, the body 110 may include a dielectric layer 111 and internal electrodes 121 and 122 alternately disposed with the dielectric layers 111. The plurality of dielectric layers 111 forming the body 110 are in a sintered state, and the boundaries between adjacent dielectric layers 111 may be integrated to the extent of being difficult to confirm without using a scanning electron microscope (SEM).

The average thickness td of the dielectric layers 111 is not particularly limited. The average thickness td of the dielectric layer 111 may be, for example, 0.1 μm to 10 μm, 0.1 μm to 5 μm, 0.1 μm to 2 μm, or 0.1 μm to 0.4 μm.

The dielectric layer 111 may be formed by preparing a ceramic slurry containing ceramic powder particle, an organic solvent, and a binder, applying and drying the slurry on a carrier film to prepare a ceramic green sheet, and then sintering the ceramic green sheet. The ceramic powder particle is not particularly limited as long as it may obtain sufficient capacitance, but for example, a barium titanate-based material, a lead composite perovskite-based material, a strontium titanate-based material, or the like may be used. Examples of the ceramic powder particle may include BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1) in which Ca(calcium), Zr(zirconium), or the like is partially solubilized, or the like. As the organic solvent, ethanol or the like may be used, and as the binder, polyvinyl butyral or the like may be used. As the organic solvent and the binder, a known material used in the art may be used.

Referring to FIG. 4, the internal electrodes 121 and 122 may include, for example, a first internal electrode 121 and a second internal electrode 122, alternately disposed in a first direction with a dielectric layer 111 therebetween. For example, the first internal electrode 121 and the second internal electrode 122, which are a pair of electrodes having different polarities, may be disposed to face each other with the dielectric layer 111 therebetween. The first internal electrode 121 and the second internal electrode 122 may be electrically separated from each other by the dielectric layer 111 disposed therebetween.

The first internal electrode 121 may be spaced apart from the fourth surface 4 and connected to the first external electrode 131 on the third surface 3. The second internal electrode 122 may be spaced apart from the third surface 3 and connected to the second external electrode 132 on the fourth surface 4.

The conductive metal included in the internal electrodes 121 and 122 may be at least one of Ni, Cu, Pd, Ag, Au, Pt, Sn, W, Ti, and alloys thereof, and in more detail, may include Ni, but the present disclosure is not limited thereto.

The average thickness te of the internal electrodes 121 and 122 is not particularly limited. The average thickness te of the internal electrodes 121 and 122 may be, for example, 0.1 μm to 3.0 μm, 0.1 μm to 1.0 μm, or 0.1 μm to 0.4 μm.

The internal electrodes 121 and 122 may be formed by applying a conductive paste for the internal electrode containing a conductive metal to a predetermined thickness on the ceramic green sheet and sintering the same. The printing method of the conductive paste for the internal electrode may use a screen printing method, a gravure printing method or the like, and the present disclosure is not limited thereto.

The average thickness td of the dielectric layer 111 and the average thickness te of the internal electrodes 121 and 122 refer to the average size of the dielectric layer 111 and the internal electrodes 121 and 122 in the first direction, respectively. The average thickness td of the dielectric layer 111 and the average thickness te of the internal electrodes 121 and 122 may be measured by scanning the first direction and second direction cross-section of the body 110 with a scanning electron microscope (SEM) at 10,000 times magnification. In more detail, the average thickness td of the dielectric layer 111 may be measured by measuring the thickness of one dielectric layer 111 at multiple points, for example, 30 points spaced equally in the second direction, and then taking the average value. In addition, the average thickness te of the internal electrodes 121 and 122 may be measured by measuring the thickness of one internal electrode 121 or 122 at multiple points, for example, 30 points spaced equally in the second direction, and then taking the average value. The 30 points spaced equally may be designated at a capacitance forming portion Ac. If these average value measurements are performed for each of 10 dielectric layers 111 and 10 internal electrodes 121 and 122 and then the average values are measured, the average thickness td of the dielectric layer 111 and the average thickness te of the internal electrodes 121 and 122 may be further generalized.

Referring to FIG. 4, the body 110 may include the capacitance forming portion Ac which is disposed inside the body and in which capacitance is formed by including first and second internal electrodes 121 and 122 disposed alternately with a dielectric layer 111 interposed therebetween, and a first cover portion 112 and a second cover portion 113 disposed on opposing surfaces of the capacitance forming portion Ac in the first direction, respectively. The cover portions 112 and 113 may basically play a role in preventing damage to the internal electrodes due to physical or chemical stress. The cover portions 112 and 113 may have a similar configuration to the dielectric layer 111 except that they do not include the internal electrodes.

The average thickness tc of the cover portions 112 and 113 is not particularly limited. The average thickness tc of the cover portions 112 and 113 may be, for example, 150 μm or less, 100 μm or less, 30 μm or less, or 20 μm or less. The average thickness tc of the cover portions 112 and 113 may be, for example, 5 μm or more, 10 μm or more, or 30 μm or more. In this case, the average thickness tc of the cover portions 112 and 113 refers to the average thickness of each of the first cover portion 112 and the second cover portion 113.

The average thickness tc of the cover portions 112 and 113 may refer to the average size of the cover portions 112 and 113 in the first direction, and may be an average value of the first direction size measured at five points at equal intervals in the second direction by scanning the cross-section of the body 110 in the first and second direction cut from the center of the body 110 in the third direction.

The cover portions 112 and 113 may be formed by stacking a predetermined number of ceramic green sheets on which the conductive paste for the internal electrode is not applied, on both surfaces of the capacitance forming portion Ac opposing each other in the first direction, and then sintering the same.

Referring to FIG. 5, the body 110 may include a first margin portion 114 and a second margin portion 115 disposed on both surfaces of the capacitance forming portion Ac opposing each other in the third direction, respectively. For example, the margin portions 114 and 115 may refer to an area between both ends of the internal electrodes 121 and 122 and the boundary surface of the body 110 in a cross-section cut in the first direction and the third direction of the body 110.

The margin portions 114 and 115 may have a similar configuration to the dielectric layer 111 except that they do not include the internal electrodes 121 and 122. The margin portions 114 and 115 may basically play a role in preventing damage to the internal electrodes 121 and 122 due to physical or chemical stress.

The margin portions 114 and 115 may be formed by applying a conductive paste for the internal electrode to the ceramic green sheet, except for the area where the margin portions are to be formed, and then sintering the same. Alternatively, to suppress the step due to the internal electrodes 121 and 122, after lamination, cutting is performed so that the internal electrodes 121 and 122 are exposed to the fifth and sixth surfaces 5 and 6 of the body, and then one or more ceramic sheets for forming the margin portion may be laminated on both sides of the capacitance forming portion Ac opposing each other in the third direction, followed by sintering, thereby forming the margin portions 114 and 115.

The average thickness tm of the margin portions 114 and 115 is not particularly limited. The average thickness tm of the margin portions 114 and 115 may be, for example, 150 μm or less, 100 μm or less, 20 μm or less, or 15 μm or less. The average thickness tm of the margin portions 114 and 115 may be, for example, 5 μm or more, 10 μm or more, or 30 μm or more. In this case, the average thickness tm of the margin portions 114 and 115 refers to the average thickness of each of the first margin portion 114 and the second margin portion 115.

The average thickness tm of the margin portions 114 and 115 may refer to the average size of the margin portions 114 and 115 in the third direction, and may be an average value of the third direction size measured at five points equally spaced in the first direction by scanning the cross-section of the body 110 in the first and third direction cut from the center of the body 110 in the second direction.

The external electrodes 131 and 132 may include a first external electrode 131 including a first connection portion C1 disposed on the third surface 3 and a first band portion B1 extending from the first connection portion C1 onto at least one of the first surface, the second surface, the fifth surface, and the sixth surface 1, 2, 5 and 6, and a second external electrode 132 including a second connection portion C2 disposed on the fourth surface 4 and a second band portion B2 extending from the second connection portion C2 onto at least one of the first surface, the second surface, the fifth surface, and the sixth surface 1, 2, 5 and 6. The first band portion B1 may extend from the first connection portion C1 to portions of the respective first, second, fifth, and sixth surfaces 1, 2, 5 and 6, and the second band portion B2 may extend from the second connection portion C2 to portions of the respective first, second, fifth, and sixth surfaces 1, 2, 5 and 6.

The first connection portion C1 may refer to an area of the first external electrode 131 positioned outside a virtual plane P3 parallel to the third surface, and the first band portion B1 may refer to an area of the first external electrode 131 positioned inwardly of the virtual plane P3 parallel to the third surface. The boundary between the first connection portion C1 and the first band portion B1 may be located on the virtual plane P3 parallel to the third surface.

The second connection portion C2 may refer to an area of the second external electrode 132 positioned outside a virtual plane P4 parallel to the fourth surface, and the second band portion B2 may refer to an area of the second external electrode 132 positioned inwardly of the virtual plane P4 parallel to the fourth surface. The boundary between the second connection portion C2 and the second band portion B2 may be located on the virtual plane P4 parallel to the fourth surface.

The first external electrode 131 may include a first base electrode layer 131a in contact with the first internal electrode 121, a first lower plating layer 131b disposed on the first base electrode layer 131a, and a first upper plating layer 131c disposed on the first lower plating layer 131b. The second external electrode 132 may include a second base electrode layer 132a in contact with the second internal electrode 122, a second lower plating layer 132b disposed on the second base electrode layer 132a, and a second upper plating layer 132c disposed on the second lower plating layer 132b.

The first base electrode layer 131a and the second base electrode layer 132a may each include a metal and glass. The first base electrode layer 131a may be disposed in the first connection portion C1 and the first band portion B1, and the second base electrode layer 132a may be disposed in the second connection portion C2 and the second band portion B2. The base electrode layers 131a and 132a may be formed by dipping the third and fourth surfaces 3 and 4 into a conductive paste including metal powder and glass frit and then sintering the same. The metal included in the base electrode layers 131a and 132a may include, for example, Cu, Ni, Pd, Pt, Au, Ag, Pb, and/or alloys thereof.

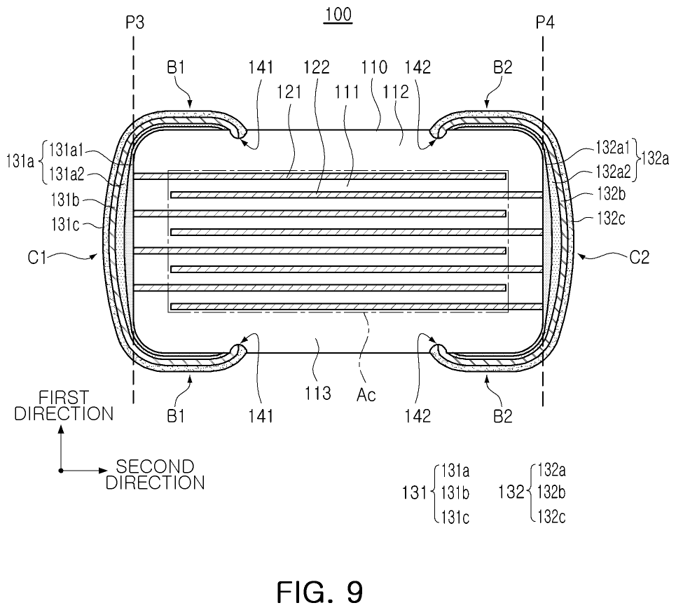

Meanwhile, the base electrode layers 131a and 132a may be composed of only one layer including a metal and glass, but the present disclosure is not limited thereto, and the base electrode layers 131a and 132a may have a multilayer structure. FIG. 9 is a modified example of FIG. 4. Referring to FIG. 9, the first base electrode layer 131a and the second base electrode layer 132a may each include a first layer 131a1 and 132al including a metal and glass, and a second layer 131a2 and 132a2 disposed on the first layer 131al and 132al and including a metal and a resin.

The metal included in the second layer is not particularly limited, and may include at least one selected from the group consisting of Ni, Cu, Pd, Ag, Au, Pt, Sn, W, Ti, and alloys thereof. The resin included in the second layer may include, for example, at least one of epoxy resin, acrylic resin, and ethyl cellulose. The second layer may be formed by applying and drying a conductive resin composition including metal powder and resin on the first layer, and then performing a curing heat treatment.

The first lower plating layer 131b and the first upper electrode layer 131c may be disposed in the first connection portion C1 and the first band portion B1, and the second lower plating layer 132b and the second upper plating layer 132c may be disposed in the second connection portion C2 and the second band portion B2. The lower plating layers 131b and 132b and the upper plating layers 131c and 132c may improve the mounting characteristics. The types of the lower plating layers 131b and 132b and the upper plating layers 131c and 132c are not particularly limited, and the lower plating layers 131b and 132b and the upper plating layers 131c and 132c may include Ni, Sn, Pd, and/or alloys thereof. In an embodiment, the first lower plating layer 131b and the second lower plating layer 132b may each include Ni, and the first upper plating layer 131c and the second upper plating layer 132c may each include Sn. The lower plating layers 131b and 132b and the upper plating layers 131c and 132c may be formed using an electrolytic plating method and/or an electroless plating method.

The drawing describes a structure in which a multilayer electronic component 100 has two external electrodes 131 and 132, but is not limited thereto, and the number or shape of the external electrodes 131 and 132 may be changed depending on the shape of the internal electrodes 121 and 122 or other uses.

The body 110 may include a first groove 141 and a second groove 142, which are respectively disposed at the ends of the first band portion B1 and the second band portion B2 and the first and second grooves 141 and 142 are spaced apart from each other. The first groove 141 may be disposed along the end of the first band portion B1, and the second groove 142 may be disposed along the end of the second band portion B2. As illustrated in FIGS. 2 and 3, the first groove 141 and the second groove 142 may respectively be disposed continuously on at least one of the first surface, the second surface, the fifth surface, and the sixth surface 1, 2, 5 and 6. In more detail, the first groove 141 and the second groove 142 may be respectively disposed continuously on the first surface, the second surface, the fifth surface, and the sixth surface 1, 2, 5 and 6. The grooves 141 and 142 may extend in the third direction from the first surface and the second surface 1 and 2, and may extend in the first direction from the fifth surface and the sixth surfaces 5 and 6.

In one embodiment, in the first direction, a lower surface of the first groove 141 may be lower than a portion of the first surface 1 in the first band portion B1 and a central portion of the first surface 1, and a lower surface of the second groove 142 may be lower than a portion of the first surface 1 in the second band portion B2 and the central portion of the first surface 1.

A method of forming the grooves 141 and 142 in the body 110 is not limited. However, since there is a risk of cracks and other defects occurring when a strong physical impact is applied to the body 110, it may be preferable to form the grooves 141 and 142 using a laser ablation method, or the like.

According to an embodiment, the ends of the first lower plating layer 131b and the first upper plating layer 131c may respectively fill at least a portion of the first groove 141, and the ends of the second lower plating layer 132b and the second upper plating layer 132c may respectively fill at least a portion of the second groove 142.

External moisture may generally penetrate into the interior of the body 110 through the ends of the external electrodes 131 and 132, for example, the ends of the band portions B1 and B2. As illustrated in FIG. 13, in the case of a multilayer electronic component of the related art in which a groove is not disposed in the body 10, external moisture may penetrate in a straight line between the body 10 and the external electrode 31. For example, in the related art case, a penetration path PM of external moisture is simple, and thus external moisture may easily penetrate into the interior of the body 10, and the reliability of the multilayer electronic component is lowered due to the external moisture penetrating into the interior of the body 10.

Meanwhile, in the case of an embodiment of the present disclosure, as illustrated in FIG. 7, the ends of the first lower plating layer 131b and the first upper plating layer 131c respectively fill at least portions of the first groove 141, thereby enabling the penetration path PM of external moisture more complicated than in the multilayer electronic component of the related art, and as a result, improving the moisture resistance reliability of the multilayer electronic component 100.

There is no need to specifically limit the shape of the groove. In FIG. 7, the cross-section of the internal space of the first groove 141 is illustrated in a semicircular shape, but the present disclosure is not limited thereto, and the cross-section of the internal space of the first groove 141 may have various shapes such as a triangle, quadrangle, trapezoid, or oval.

There is no need to specifically limit the size of the groove. However, in an embodiment, a first direction maximum size T1 of the first groove may be 2 μm to 20 μm. If the T1 is less than 2 μm, the moisture-resistant reliability improvement effect of the present disclosure may be insignificant. If the T1 exceeds 20 μm, an empty space that is not filled by the first lower plating layer 131b and the first upper plating layer 131c in the first groove 141 may be excessively generated, and there is a concern that foreign substances may penetrate the empty space and cause a defect in the multilayer electronic component 100. In an embodiment, a second direction maximum size L1 of the first groove may be 2 μm to 20 μm. If the L1 is less than 2 μm, the moisture-resistant reliability improvement effect of the present disclosure may be insignificant. If the L1 exceeds 20 μm, an excessive size of empty space may occur in the first groove 141, not filled by the first lower plating layer 131b and the first upper plating layer 131c, and there is a concern that foreign substances may penetrate into the empty space and cause defects in the multilayer electronic component 100.

Meanwhile, it is sufficient if the lower plating layers 131b and 132b and the upper plating layers 131c and 132c each fill at least portions of the grooves 141 and 142, and the form in which the lower plating layers 131b and 132b and the upper plating layers 131c and 132c are disposed within the grooves 141 and 142 is not particularly limited. However, in an embodiment, the end of the first lower plating layer 131b may fill an area of the first groove 141 adjacent to the first connection portion C1, and the end of the first upper plating layer 131c may fill an area remaining in the first groove 141 except for the area adjacent to the first connection portion. The end of the second lower plating layer 132b may fill an area of the second groove 142 adjacent to the second connection portion C2, and the end of the second upper plating layer 132c may fill an area remaining in the second groove 142 except for the area adjacent to the second connection portion. It may be preferable that the lower plating layers 131b and 132b and the upper plating layers 131c and 132c completely fill the inner space of the grooves 141 and 142, but the present disclosure is not limited thereto.

In addition, it is sufficient that the lower plating layers 131b and 132b and the upper plating layers 131c and 132c respectively fill at least portions of the grooves 141 and 142, and the ends of the base electrode layers 131a and 132a may be disposed within the grooves 141 and 142 or may not be disposed within the grooves 141 and 142. For example, referring to FIG. 7, the end of the first base electrode layer 131a may not be disposed within the first groove 141.

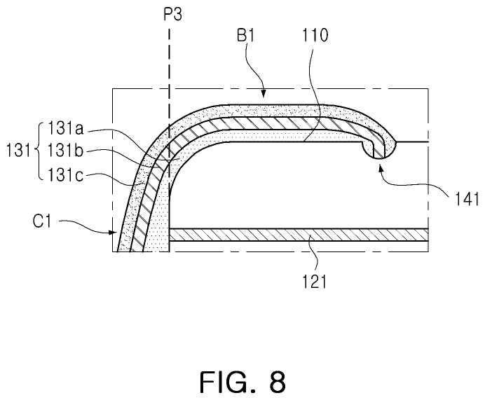

FIG. 8 is a modified example of FIG. 7. Referring to FIG. 8, in an embodiment, the end of the first base electrode layer 131a may fill at least a portion of the first groove 141. In this case, the end of the first base electrode layer 131a, the end of the first lower plating layer 131b, and the end of the first upper plating layer 131c may be disposed in the order of close to the first connection portion C1 within the first groove 141.

Meanwhile, FIGS. 7 and 8 are enlarged views illustrating the first external electrode 131 and the first groove 141, but since the first external electrode 131 and the first 141 groove have substantially the same configuration as the second external electrode 132 and the second groove 142, the description of FIGS. 7 and 8 may be equally applied to the second external electrode 132 and the second groove 142.

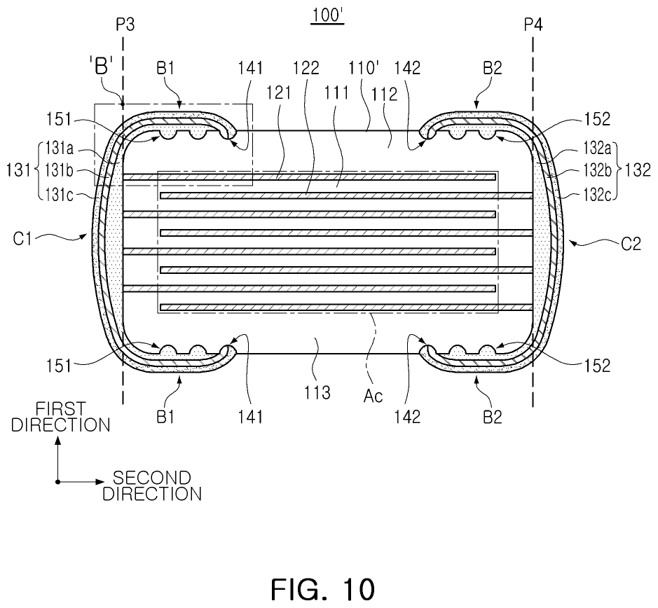

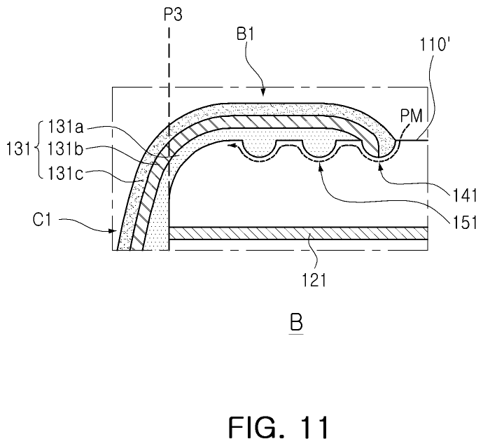

FIG. 10 is a cross-sectional view schematically illustrating a multilayer electronic component 100′ according to another embodiment, and is a drawing corresponding to FIG. 4. FIG. 11 is an enlarged view of area B of FIG. 10.

Hereinafter, the multilayer electronic component 100′ according to another embodiment will be described with reference to FIGS. 10 and 11. The same/similar reference numerals are used for the configurations identical/similar to those of the multilayer electronic component 100 described in FIGS. 1 to 7, and duplicate descriptions are omitted.

A body 110′ of the multilayer electronic component 100′ according to an embodiment may include a first additional groove 151 covered by a first base electrode layer 131a disposed in a first band portion B1, and a second additional groove 152 covered by a second base electrode layer 132a disposed in a second band portion B2. For example, the body 110′ may include the first additional groove 151 covered by the first band portion B1 and the second additional groove 152 covered by the second band portion B2.

The additional grooves 151 and 152 may be disposed continuously on at least one of the first surface, the second surface, the fifth surface and the sixth surface 1, 2, 5 and 6. In more detail, the additional grooves 151 and 152 may be disposed continuously on the first surface, the second surface, the fifth surface, and the sixth surface 1, 2, 5 and 6.

In the case of the multilayer electronic component 100′ according to an embodiment, the first base electrode layer 131a may fill at least a portion of the first additional groove 151, and the second base electrode layer 132a may fill at least a portion of the second additional groove 152. In this case, as illustrated in FIG. 11, the penetration path PM of external moisture may be made more complicated, and as a result, the moisture resistance reliability of the multilayer electronic component 100′ may be more effectively improved. In an embodiment, the first additional groove 151 and the second additional groove 152 may each be disposed in multiple numbers. When a plurality of additional grooves 151 and 152 are disposed, the effect of improving the moisture resistance reliability of the present disclosure may be more significant. The shape and size of the additional grooves s 151 and 152 need not be particularly limited, but the additional grooves 151 and 152 may have a shape and size similar to those of the grooves 141 and 142.

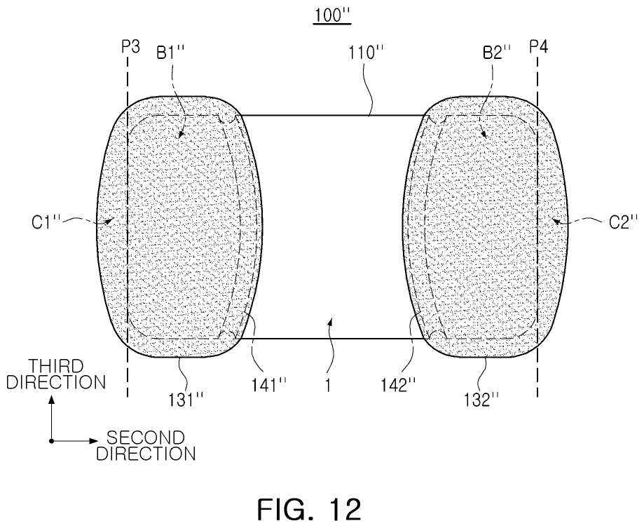

FIG. 12 is a plan view of a multilayer electronic component 100″ according to another embodiment, and is a drawing corresponding to FIG. 3.

Hereinafter, the multilayer electronic component 100″ according to another embodiment will be described with reference to FIG. 12. The same/similar reference numerals are used for the configurations identical/similar to those of the multilayer electronic component 100 described in FIGS. 1 to 7, and duplicate descriptions are omitted.

The multilayer electronic component 100″ according to an embodiment may include a first external electrode 131″ including a first connection portion C1” and a first band portion B1″, and a second external electrode 132″ including a second connection portion C2″ and a second band portion B2″.

According to an embodiment, the central portions of the first band portion B1″ and the second band portion B2″ in the third direction are larger in the second direction than both ends of the first band portion B1″ and the second band portion B2″ in the third direction, respectively, on the first surface. At this time, the first groove 141″ of the body 110″ may be disposed along the end of the first band B1″, and the second groove 142″ may be disposed along the end of the second band B2″. Accordingly, the third-direction ends of the grooves 141″ and 142″ may be closer to the third surface 3 and the fourth surface 4 of the body 110′, respectively, than the third-direction central portion of the grooves 141″ and 142″.

Thereby, the first base electrode layer is prevented from completely filling the first groove, so that it is easy to fill the first groove with the ends of the first lower plating layer and the first upper plating layer, and the second base electrode layer is prevented from completely filling the second groove, so that it is easy to fill the second groove with the ends of the second lower plating layer and the second upper plating layer. As a result, the moisture resistance reliability of the multilayer electronic component 100″ may be improved more effectively.

As set forth above, a multilayer electronic component having excellent reliability may be provided.

The present disclosure is not limited by the above-described embodiments and accompanying drawings, but is intended to be limited by the appended claims. Therefore, various forms of substitution, modification and change will be possible by those skilled in the art within the scope of the technical spirit of the present disclosure described in the claims, and this will also be said to fall within the scope of the present disclosure.

In addition, the expression ‘an embodiment’ does not indicate the same embodiment, and is provided to emphasize and describe different unique characteristics. However, the embodiments presented above are not excluded from being implemented in combination with features of another embodiment. For example, even if a matter described in one specific embodiment is not described in another embodiment, it may be understood as a description related to another embodiment, unless there is a description to the contrary or contradicting the matter in another embodiment.

In addition, expressions such as first and second are used to distinguish one component from another, and do not limit the order and/or importance of the components. In some cases, without departing from the scope of rights, a first element may be named a second element, and similarly, a second element may be named a first element.

While embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a dielectric layer, and a first internal electrode and a second internal electrode alternately disposed with the dielectric layer therebetween, the body including a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction;
a first external electrode including a first connection portion disposed on the third surface and a first band portion extending from the first connection portion onto at least one surface among the first surface, the second surface, the fifth surface, and the sixth surface; and
a second external electrode including a second connection portion disposed on the fourth surface and a second band portion extending from the second connection portion onto at least one surface among the first surface, the second surface, the fifth surface, and the sixth surface,
wherein the first external electrode includes a first base electrode layer in contact with the first internal electrode, a first lower plating layer disposed on the first base electrode layer, and a first upper plating layer disposed on the first lower plating layer,
the second external electrode includes a second base electrode layer in contact with the second internal electrode, a second lower plating layer disposed on the second base electrode layer, and a second upper plating layer disposed on the second lower plating layer,
the body includes a first groove and a second groove disposed on ends of the first and second band portions, respectively, and spaced apart from each other, and
ends of the first lower plating layer and the first upper plating layer respectively fill at least portions of the first groove, and ends of the second lower plating layer and the second upper plating layer respectively fill at least portions of the second groove.

2. The multilayer electronic component of claim 1, wherein the end of the first lower plating layer fills an area of the first groove, closer to the first connection portion, and the end of the first upper plating layer fills a remaining area of the first groove except for the area of the first groove filled by the end of the first lower plating layer, and
the end of the second lower plating layer fills an area of the second groove, closer to the second connection portion, and the end of the second upper plating layer fills a remaining area of the second groove except for the area of the second groove filled by the end of the second lower plating layer.

3. The multilayer electronic component of claim 1, wherein the first and second grooves are continuously disposed on at least one of the first surface, the second surface, the fifth surface, and the sixth surface.

4. The multilayer electronic component of claim 1, wherein each of the first and second grooves is continuously disposed on the first surface, the second surface, the fifth surface, and the sixth surface, respectively.

5. The multilayer electronic component of claim 1, wherein an end of the first base electrode layer is not disposed inside the first groove.

6. The multilayer electronic component of claim 1, wherein an end of the first base electrode layer fills at least a portion of the first groove.

7. The multilayer electronic component of claim 6, wherein the end of the first base electrode layer, the end of the first lower plating layer and the end of the first upper plating layer are disposed within the first groove in an order close to the first connection portion.

8. The multilayer electronic component of claim 1, wherein a maximum size of the first groove in the first direction is 2 μm to 20 μm.

9. The multilayer electronic component of claim 1, wherein a maximum size of the first groove in the second direction is 2 μm to 20 μm.

10. The multilayer electronic component of claim 1, wherein the body further includes at least one first additional groove covered by the first base electrode layer disposed in the first band portion, and at least one second additional groove covered by the second base electrode layer disposed in the second band portion, and
the first base electrode layer fills at least a portion of the at least one first additional groove, and the second base electrode layer fills at least a portion of the at least one second additional groove.

11. The multilayer electronic component of claim 10, wherein the at least one first additional groove and the at least one second additional groove are disposed in plural.

12. The multilayer electronic component of claim 1, wherein central portions of the first and second band portions in the third direction are larger in the second direction than both ends of the first and second band portions in the third direction, respectively, on the first surface, and
the first groove is disposed along the end of the first band portion, and the second groove is disposed along the end of the second band portion.

13. The multilayer electronic component of claim 12, wherein, on the first surface of the body:
both ends of the first groove in the third direction are closer to the third surface of the body in the second direction than a central portion of the first groove in the third direction, and
both ends of the second groove in the third direction are closer to the fourth surface of the body in the second direction than a central portion of the second groove in the third direction.

14. The multilayer electronic component of claim 1, wherein the first and second base electrode layers each include a metal and glass.

15. The multilayer electronic component of claim 1, wherein the first and second base electrode layers respectively include a first layer including a metal and glass, and a second layer disposed on the first layer and including a metal and resin.

16. The multilayer electronic component of claim 1, wherein the first and second lower plating layers each contain Ni, and
the first and second upper plating layers each contain Sn.

17. The multilayer electronic component of claim 1, wherein in the first direction:
a lower surface of the first groove is lower than a portion of the first surface in the first band portion and a central portion of the first surface, and
a lower surface of the second groove is lower than a portion of the first surface in the second band portion and the central portion of the first surface.
